(19) United States
(12) Patent Application Publication
(10) Pub. No.: US 2009/0129281 A1
(43) Pub. Date: May 21, 2009

(54) QUALITY-ENERGY SCALABILITY TECHNIQUE FOR TRACKING SYSTEMS

(75) Inventor: Min Li, Leuven (BE)

Correspondence Address: KNOBBE MARTENS OLSON & BEAR LLP, 2040 MAIN STREET, FOURTEENTH FLOOR, IRVINE, CA, 92614, US

(73) Assignee: Interuniversitair Microelektronica Centrum (IMEC), Leuven (BE)

(21) Appl. No.: 11/944,324

(22) Filed: Nov. 21, 2007

(51) Int. Cl. H04L 12/26

(52) U.S. Cl. 370/252

(57) ABSTRACT

A method of managing the operation of a system is presented. The system includes a processing subsystem configured to run a multimedia application and a telecommunication subsystem. The method includes determining telecom environment conditions, and selecting a configuration from a plurality of configurations. The selecting is based at least in part on the determined environmental conditions. The method also includes setting control parameters such as channel speed in the multimedia application and/or the telecommunication subsystem to cause the system to operate at the selected configuration, and operating the system at the selected configuration. The configuration are determined by simultaneously updating control parameters by a controller of both the multimedia application and the telecommunication subsystem.

### BACKGROUND

1. Field

The field relates to a framework providing quality-energy scalability for tracking systems.

2. Description of Related Technology

By applying increasingly more sophisticated signal processing techniques, wireless communications have made remarkable breakthroughs during the last decades in the improvement of spectrum efficiency and throughput. However, although the progress on the algorithm side is pretty exciting, the implementation of these communication signal processing algorithms falls far behind. It was observed that the signal processing requirement (complexity) increases exponentially with the increment of spectrum efficiency. Hence, although Moore's law predicts a fast evolution of the semiconductor integration, the new birth of silicon capability is rapidly exhausted by the explosion of signal processing complexity in wireless communication.

On the other hand, the gap between silicon capability and battery capacity, which is caused by the slow progress in battery technology, is another constraint that prevents sophisticated signal processing functions from being implemented on real life platforms. The power barrier becomes even more challenging in the context of Software Defined Radio (SDR), which offers unique programmability and flexibility at the expense of much higher power consumption than for highly optimized Application Specific Integrated Circuits (ASICs). Quality-Energy scalability, which allows scalable tradeoff between quality and signal processing energy, has been recognized as an effective and important approach toward energy efficient design. This general design philosophy has been intensively applied in wireless video delivery, low power filtering, multimedia codec, and cross layer energy management in wireless network.

First, state-of-the-art wireless systems devices are built to operate at only a fixed set of operating points and assume the worst-case conditions at all times. Irrespective of the link utilization, the highest feasible PHY rate is always used and the power amplifier operates at the maximum transmit power. Indeed, when using non-scalable transceivers, this highest feasible rate results in the smallest duty cycle for the power amplifier. Compared to scalable systems, this results in excessive energy consumption for average channel conditions and average link utilizations.

To achieve this goal, flexible systems must be specified having so-called configuration knobs that can be set at run-time to affect jointly the performance and energy consumption. The higher the flexibility, i.e. the number of configuration knobs across all layers, the higher the potential gain due to a better match between the system behavior, the environment and the real user requirements. However, a penalty exists due to the required shift, at least partially, of the optimization process to run-time. This is very challenging due to the combinatorial character of the problem (the number of candidate configurations rises exponentially with the number of controlled knobs).

Equalization is one of key stages in a wireless transceiver. In “C. Nicol et al., A low-power 128-tap digital adaptive equalizer for broadband modems, IEEE Journal of Solid-State Circuits, vol. 32, no. 11, pp. 177-1789, November 1997” a low power equalizer is introduced deploying 128 taps and symbol-rate power-of-two Least Mean Squares updating. In “K. Tarumi et al., A power reduction technique for an equalization circuit using adaptive bitwidth control, IEICE Technical Report, CAS2004-16, VLD2004-27, SIP2004-30, pp. 37-41, June 2004”, a low power equalizer is presented utilizing bitwidth control. Quality-Energy scalability was not targeted.

### SUMMARY

Certain embodiments provide a method for operating a telecom system, more in particular a wireless system, with a globally optimized power consumption for a given quality of service. Other embodiments further aim to provide devices suited to the method.

One embodiment includes a method of managing the operation of a system including a processing subsystem configured to run a multimedia application and a telecommunication subsystem. The method includes determining telecom environment conditions, and selecting a configuration from a plurality of configurations. The selecting is based at least in part on the determined environmental conditions. The method also includes setting control parameters such as channel speed in the multimedia application and/or the telecommunication subsystem to cause the system to operate at the selected configuration, and operating the system at the selected configuration. The configurations are determined by simultaneously updating control parameters by a controller of both the multimedia application and the telecommunication subsystem.

In another embodiment, the telecommunication subsystem comprises a receiver having an equalization block. The proposed scheme has several remarkable advantages when comparing to the related work. First of all, it implicitly tracks the higher order stochastic behavior with a simple feedback controller, so that the design effort and run-time overhead of an explicit estimator is avoided. In addition, since the scalability is achieved with high level algorithmic techniques, it does not impose any special requirement on the implementation platform, so that the equalizer can be implemented on various baseband platforms including ASIC, FPGA or instruction-set processors. Moreover, the proposed technique is independent of the updating algorithm. A QRD-RLS based chip equalizer can be considered. Since the technique works at high level by controlling macro (coarse-grain) operations, the overhead of scalability is low compared to the cost of each macro operation of QR updating. It does not conflict with lower level techniques such as for example selective updating and sub-band updating. The technique is not limited hereto but for example directly applicable to other updating algorithms such as LMS (and its variants), Kalman filter, . . . .

Another embodiment comprises a device suited to the method. The selection of a configuration comprises updating an equalization error by means of a controller. The updating interval is controlled by the speed of the channel fading. Usually the equalizer makes the pessimistic assumption that the channel is always changing very rapidly so that intensive tracking is necessary. In conventional equalizers, the coefficients are updated according to the worst-case assumption that the channel is very dynamic. The proposed invention avoids over-updating.

For example, in traditional ASIC based equalizers, the length of equalization is often determined as a worst-case value. Chip level equalization has been shown to be very effective to restore the orthogonal user signals and suppresses the MAI. As a consequence, it attracted lots of interest in the HSDPA research, which targets further improvement for 3G. However, the performance gain of chip level equalization comes at a huge energy cost because of the very high chip rate and the inherent complexity in advanced adaptive filter algorithms. Hence, achieving Quality-Energy scalability in chip HSDPA level equalization could contribute to their adoption in actual systems.

### BRIEF DESCRIPTION OF THE DRAWINGS

FIG. 1 represents the framework of the equalizer of the present invention.

FIG. 2 shows plots of the run-time behavior of the proposed scheme.

FIG. 3 plots the BER versus the normalized energy cost.

FIG. 4 plots the BER Loss versus the normalized energy cost.

FIG. 5 is a flowchart showing a method of managing the operation of a telecommunication system according to an embodiment.

### DETAILED DESCRIPTION OF CERTAIN INVENTIVE EMBODIMENTS

Currently proposed techniques to exploit the energy-performance trade-off in wireless links mainly rely on the reduction of the transmit-power. However, when considering the energy consumption breakdown of practical IEEE 802.11a WLAN transceivers, it appears that the transmit-power itself accounts only for 8% of the total energy consumption of the transmitter. The Power Amplifier (PA) dominates with 49%. Moreover, due to the stringent linearity and spectral mask requirements of the OFDM modulation, class A power amplifiers are most often required. Consequently, the actual energy consumption of the PA is invariant with the transmitted power. On the other hand, traditional receiver architectures are dimensioned for the most demanding modulation and present constant processing gain. Therefore, only the duty cycle effectively affects the link energy consumption. In that context, the highest modulation order that goes through the channel with reasonable packet error rate (i.e. 1%) is always the best choice. Performance (i.e. net data rate) downscaling does not bring effective energy consumption reduction.

For the receiver, it appears that the energy consumption is dominated by the digital signal processing in which the forward error correction accounts for an important part. Scalability in receiving energy consumption can be achieved by trading off processing gain (and consequently, receiver sensitivity) and computing energy by activating more or less digital signal processing. This can be achieved for instance by adopting iterative forward error correction (FEC) schemes like turbo-codes. Turbo-codes can be implemented with low energy consumption and provide a wide freedom to trade-off energy consumption versus code gain, which translates in receiving processing gain.

In US patent publication 2006/0114836 and U.S. application Ser. No. 11/247,403, which are hereby incorporated in its entirety, settings of new functional parameters are explored for deriving the optimal trade-off between the net data rate on top of the data-link layer (goodput) and the total link energy consumption. These are defined as the system level control knobs used to bring energy-scalability.

When considering energy-scalable systems, the number of control dimensions is large and leads to a combinatorial explosion of the possible system configurations. This problem is solved efficiently in US patent application 2006/0114836. A pragmatic scheme is provided to select the configurations at runtime. This is achieved by first determining the optimal configurations of all control dimensions at design time. At runtime, based on the channel condition and application load, the best operating point is selected from a significantly reduced set of possibilities.

A property of the design-time phase model is that the configurations can be ordered according to their minimal cost and resource consumption, describing a range of possible costs and resources for the system. For each additional unit of resource allocated, one only needs to consider the configuration that achieves the minimal cost for that unit of the resource. For each possible system state (for different channel and application loads), the optimal operating points are determined by pruning the Cost-Resource (C-R) curves to yield only the minimum cost configurations at each resource allocation point.

The optimization process can lead to much better solutions if all the factors are taken into account in a cross-layer approach. This way, we explore the cross-layer interdependencies and joint optimizations for varying network and video coding settings. The application of this approach is illustrated in an embodiment. The approach can be implemented into a framework providing quality-energy scalability for tracking systems. In particular, a feedback control scheme is presented to achieve Quality-Energy scalability for the chip level equalization in High Speed Downlink Packet Access (HSDPA) receivers.

The chip-level equalizer is an adaptive equalizer whose coefficients are derived from a pilot symbol. As a consequence, a key part of the equalizer is a set of algorithms estimating the Channel Impulse Response (CIR). Usually the equalizer makes the pessimistic assumption that the channel is always changing rapidly so that intensive tracking is necessary. This results in worst-case design with respect to energy consumption. In conventional equalizers, the coefficients are updated according to the worst-case assumption that the channel is very dynamic. In our proposed approach, the speed of the channel variation is taken into account to adapt the updating frequency. Specifically, a low-complexity closed-loop controller is designed to vary the update-interval while limiting the maximum equalization error. The proposed control scheme takes high order channel statistics implicitly into account without the need for an explicit estimator.

Instead of continuous updating at a high frequency, a more adaptive way is proposed to update the coefficients according to the speed of the channel fading. A feedback controller is added to a conventional chip level equalizer. The controller alters the update interval based on a maximum equalization error. Since the equalization error has a monotonic relationship with both the BER and signal processing energy, Quality-Energy scalability can be achieved by varying the set-point for the equalization error.

First the basic elements of one embodiment of the system model are given. Consider the downlink of a multiple cell Wideband Code Division Multiple Access (CDMA) system with j active base stations. Each base-station transmits a synchronous code division multiplex, employing, for example, short orthogonal Walsh-Hadamard spreading codes that are user specific and a long overlay scrambling code that is base-station specific. The multi-user chip sequence, transmitted by the j^{th} base-station, consists of Kⱼ active user signals and a continuous pilot signal:

$${x}^{j} [ n ] = {\sum }_{k = 1}^{{K}_{j}} {s}_{k}^{j} [ i ] {c}_{k}^{j} [ mod ( n , ρ N ) ] + {s}_{p}^{j} [ i ] {c}_{p}^{j} [ mod ( n , ρ N ) ] \qquad ( 1 )$$

Where i=└n/N┘.

Each user's data symbol sequence sₖ^{j}[i] (pilot symbol sequence sₚ^{j}[i]) is spread by a factor N with the length ρN user composite code sequence cₖ^{j}[n] (pilot composite code sequence cₚ^{j}[n]). The k^{th} user's composite code sequence for the j^{th} base-station cₖ^{j}[n] (pilot composite code sequence cₚ^{j}[n]) is the multiplication of the user specific pilot specific) short Walsh-Hadamard spreading code and the base-station specific long scrambling code.

The mobile station is equipped with M receive antennas. The received antenna signals are sampled at the chip-rate 1/T_{c} and the obtained samples are stacked in the M×1 received vector sequence y[n]=[y₁[n], y₂[n], . . . , y_{M}[n]]^{r}, which can be written as:

$$y [ n ] = {\sum }_{j = 1}^{J} {\sum }_{{n}^{′} = {δ}_{j}}^{{δ}_{j} + {L}_{j}} {h}^{j} [ {n}^{′} ] {x}^{j} [ n - {n}^{′} ] + e [ n ] \qquad ( 2 )$$

Where e[n]=[e₁[n], e₂[n], . . . , e_{M}[n]]^{τ} is the received noise vector sequence and h[n]=[h₁[n], h₂[n], . . . , h_{M}[n]]^{τ} is the discrete-time vector channel from the j^{th} base-station to the M receive antennas, modeled as an M×1 FIR vector filter of order Lⱼ with delay index δⱼ.

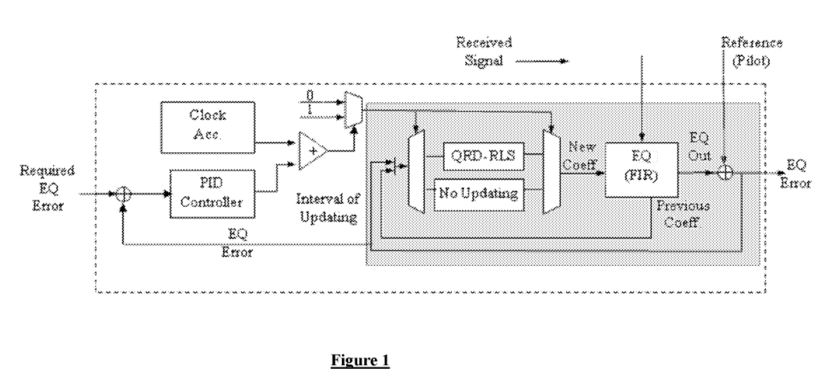

The abstract model of pilot based adaptive equalizer is depicted in the dotted square in FIG. 1. The equalization is performed with a complex-tap FIR filter, and the coefficients of the FIR filter are adapted based on the error between the equalizer output and the known pilot (reference signal).

In this embodiment, the mathematical optimization criterion of the adaptive equalizer is the least square error as formulated in the following:

$${g}_{{a}_{j}}^{j} = {arg min}_{{g}_{{a}_{j}}^{j}} E ( {‖ {g}_{{a}_{j}}^{j} {Y}_{{a}_{j}} {C}_{p}^{{j}^{H}} - {s}_{p}^{j} ‖}^{2} ) \qquad ( 3 )$$

where gₐ_{ⱼ}^{j} is the complex weighting vector to optimize, Yₐ_{ⱼ} is the received data, Cₚ^{j}^{^{H}} is the pilot code matrix of the j^{th} base-station and, sₚ^{j} is the transmitted pilot symbol which is known by the receiver a priori. The interpretation of Eq. (3) is: the equalized signal gₐ_{ⱼ}^{j}Yₐ_{ⱼ} for the j^{th} base-station is despread with the pilot code matrix of the j^{th} based-station. The equalized signal after despreading, gₐ_{ⱼ}^{j}Yₐ_{ⱼ}Cₚ^{j}^{^{H}} should then be as close as possible to the known pilot symbol vector sₚ^{j} in least square sense.

There are many algorithm options for updating the equalization coefficients, most of them are variants of LMS RLS and Kalman filter. Here, QRD-RLS is used because of its fast convergence and numerical stability.

Conventional equalizers usually make the assumption that the channel dynamics are significant. As discussed before, this design paradigm has several disadvantages because of its-worst-case philosophy. Although consecutive updating is necessary for a fast fading channel, for instance between a highway vehicle and the base-station, consecutive updating is overkill for a slow fading channel. The energy cost of over-updating does not bring noticeable performance gain. Hence, to optimize, the update interval according to the speed of the speed channel fading can be adjusted.

Ideally, an estimator/monitor can be designed for the variation of the channel dynamics, and an optimal update interval might be analytically derived with the given constraints on quality (BER) losses. However, an accurate estimator itself is very difficult to design and the signal processing cost of an estimator itself is high because it deals with higher order stochastic behavior.

A feedback control scheme is proposed, comprising an explicit estimator for the variation of channel dynamics and the controller is designed to control the penalty of decreasing the update rate. Although the BER degradation is the direct consequence of a too low update rate, sometimes it is not feasible to measure the BER during run-time.

Defining equalization-error as the error between pilot symbols and outputs of the equalizer, we can easily deduce that an improperly large update interval will incur noisy CIR estimation, large equalization-error and large BER loss. Hence, we take the equalization error as a penalty metric and design a controller to alter update rate with controlled equalization error. In the chip level equalization case, the equalization error is:

θ=gₐ_{ⱼ}^{j}Yₐ_{ⱼ}Cₚ^{j}^{^{H}}−sₚ^{j} (4)

With control system terminology, the controlled variable in the proposed controller is the equalization error and the controlling/manipulating variable that the controller adjusts is the update interval.

The framework of the Quality-Energy scalable equalizer, with variable update interval and controlled equalization-error, is depicted in FIG. 1. The error between the set-point of the equalization-error and measured equalization-error is fed back to the controller which alters the update interval.

The dynamics model of the underlying system is hard to identify using general techniques and the high chip rate in CDMA strictly requires the controller to be simple. Hence we use a PID control algorithm. PID controllers are widely used in control systems dealing with complex or unknown dynamics. The PID controller works in a closed-loop system as following:

$$u = {K}_{P} e + {K}_{I} \int e d t + {K}_{D} \frac{d e}{d t} \qquad ( 5 )$$

Where K_{P} is Proportional gain, K_{I} is Integral gain and K_{D} is Derivative gain. The variable e represents the tracking error that indicates the difference between the set-point of equalization-error and the measured equalization-error. The controlling variable u in this case is the interval for updating.

The controller introduces a very small overhead. When implemented in discrete time domain, the PID computation in Eq. (5) consists of three multiplications, four additions, and two extra registers/storage units for the integration and differentiation operator. Furthermore, a counter and a comparator are required for deciding to update or not. However, one QR updating operation has the complexity of Θ(JQMN+JQ²M²), where J is the number of active base-station, Q is the temporary smoothing factor depending on channel conditions, M is the number of antenna, and N is the spreading factor. Since Q is often assumed to be large in practical implementations, the complexity of QR updating itself is magnitudes larger than the overhead of the proposed controller.

In the following, simulation results are given. The parameters of the simulation set-up follow the specifications of HSDPA. The transmitted signal encounters frequency selective fading. The wireless channels in the simulator are implemented as linear time variant FIR filters. Independent Rayleigh fading components (JAKE's model) are multiplied on the sampling instants. In order to evaluate the proposed technique under various realistic scenarios, we did simulation for a set of power-delay profiles of multiple-path channel as specified in 3GPP.

In order to evaluate the energy cost of signal processing, we record the number of updating-operation during simulation. Defined over an observation window with fixed length, the normalized cost is defined as λ=α/φ, where φ is the length of the observation window and α is the number of updating-operation performed in the observation window. If updating is performed at all intervals in the observation window, we have α=φ and λ=1.

Since the updating in QRD-RLS is a deterministic coarse-grain (macro) operation, it takes a fixed amount of cycles on processor based baseband and invokes an approximately constant amount of activities on various architecture components such as arithmetic units, load/store units, memory hierarchy and buses. Hence, λ is a good estimate for the normalized energy consumption of the proposed scalable chip level equalizer.

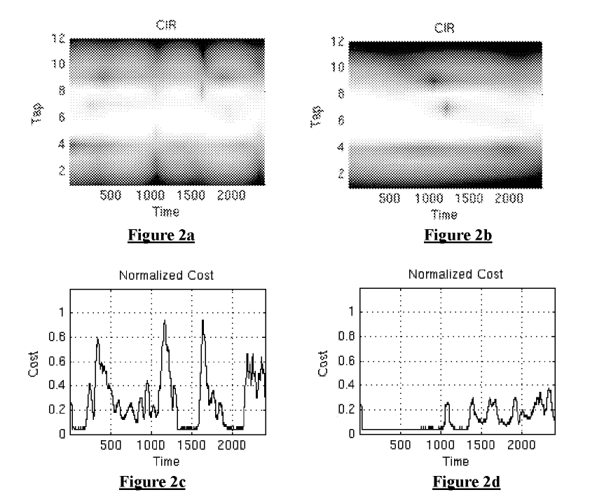

The run time behavior of the scalable equalizer is illustrated in FIG. 2. FIG. 2 (a) shows the time-varying CIR of an instance of “channel case 2”, in which the mobile terminal moves at 120 km/h. In FIG. 2 (a) the amplitude of CIR taps are represented by the brightness of pixels, and higher brightness means larger value. The brightness of pixels changes over the time axis and this implies that the CIR is varying. FIG. 2 (c) shows the normalized cost of the equalizer with controlled equalization-error. By inspecting the time index of the peaks in FIG. 2(c) and comparing them with FIG. 2 (a), we can see that these peaks appear only when the CIR varies rapidly. Hence, we can conclude that the equalizer performs intensively updating only when channel fading is in fast phase. This validates that the scalable equalizer is aware of the variation of channel dynamics even without an explicit estimator for it. An additional example of channel case 7 (50 km/h) is given in FIG. 2 (b)(d), where we have similar observations.

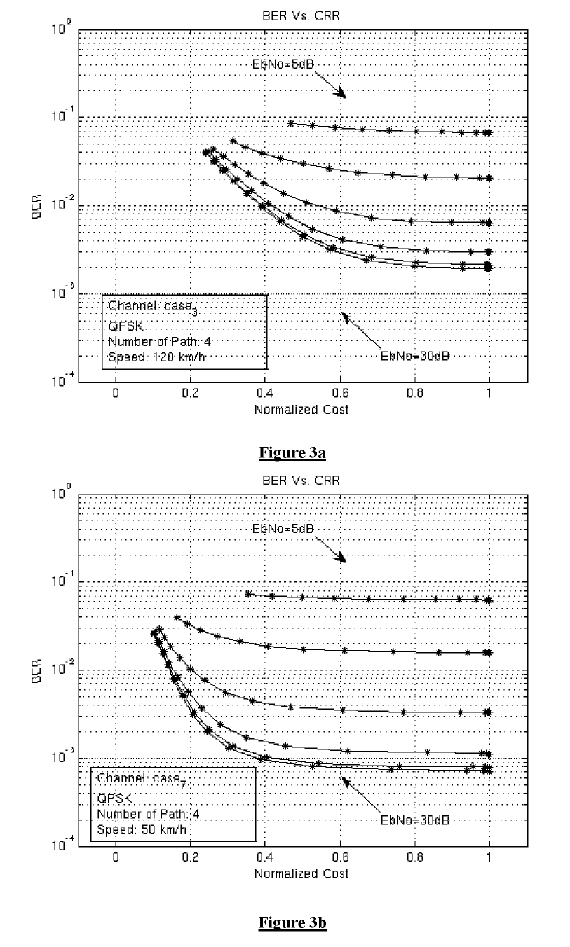

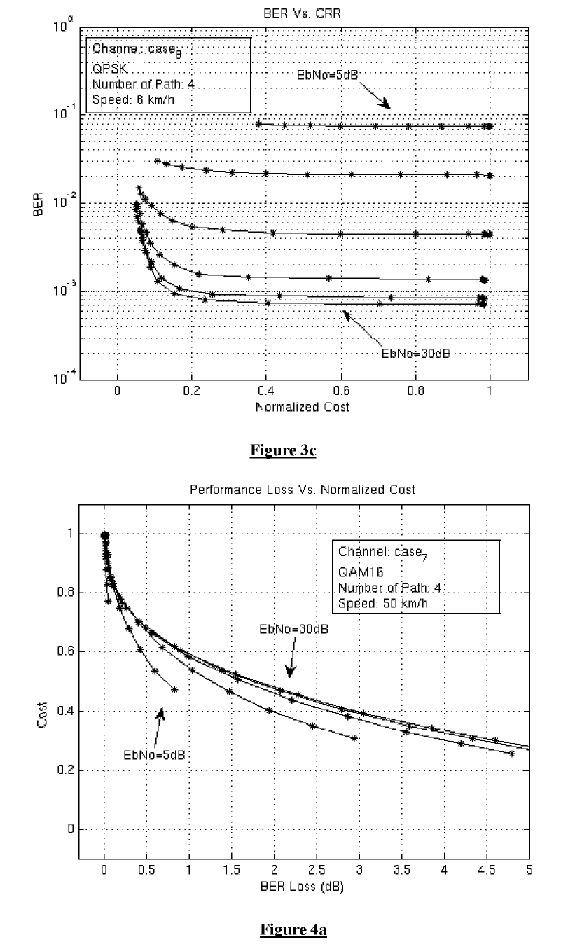

Second, we studied the Quality-Energy scalability achieved by the proposed equalizer. In FIG. 3 we plot BER versus normalized energy cost for several cases. The Pareto curves shown in these plots clearly indicate the Quality-Energy scalability. In addition, we can observe that the BER is a nonlinear function of the normalized energy cost. When the normalized energy cost grows slightly, the BER decreases very rapidly. However, when BER is close enough to a minimum the further increment of cost does NOT bring significant BER gain anymore. From another point of view, the observation strongly implies that significant signal processing energy cost can be saved with negligible BER degradation for some cases.

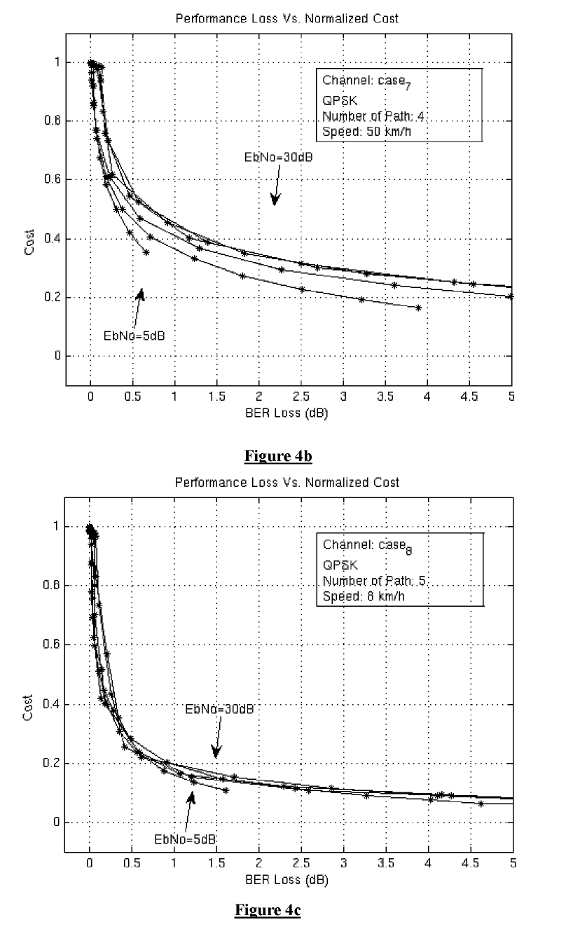

In order to quantify the relationship between BER loss and potential cost reduction, we plot BER loss versus normalized energy cost in FIG. 4. For the QAM16 and moderate mobility case shown in (a), 0.25 dB BER loss can bring 25%-30% energy cost reduction. For the QPSK and moderate mobility case shown in (b), 0.25 dB BER loss can bring 30%-45% energy reduction. For the pedestrian speed, QPSK case shown in (c), 0.25 dB BER loss can bring about 60% energy reduction. Further cost reduction can be achieved for larger BER losses. The examples prove that scalability design in equalizers can bring considerable cost reductions for signal processing.

Pilot-trained adaptive equalizers are designed for tracking channel dynamics. Although the coefficients are updated to adapt to the channel dynamics, the way of updating is not adaptive. In order to maximize the quality of equalization, continuous updating is often applied. This is based on the worst-case assumption that the wireless channel is always varying rapidly. This worst-case design suffers from unnecessary high signal processing energy cost when the channel is not in those extreme cases.

In contrast to this worst case approach, we designed a channel equalizer that adapts to the variation of the channel dynamics as well. Specifically, we proposed a simple feedback control scheme to alter the update interval while controlling the equalization-error.

We applied this approach on a QRD-RLS based HSDPA chip level equalizer. Simulation results show that the proposed scheme implicitly made the equalizer aware of the higher order stochastic behavior in the wireless channel. In addition, the desired Quality-Energy scalability was achieved in the HSDPA chip level equalizer, and this translates into a significant saving of signal processing energy cost with negligible quality degradations for slow varying channels. Specifically, for a pedestrian channel, 60% signal processing cost can be saved with only 0.25 dB BER loss.

The proposed scheme has a number of advantages. First, it tracks the variation of the channel dynamics without paying the expensive cost of an explicit estimator of higher order statistics. Second, it is a high level algorithmic technique so that it has full portability over different baseband platforms. Third, the overhead is very low when compared to the QRD based updating operation. Finally, it is very general so that it can be applied to other adaptive filters applications with minor modifications.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention.

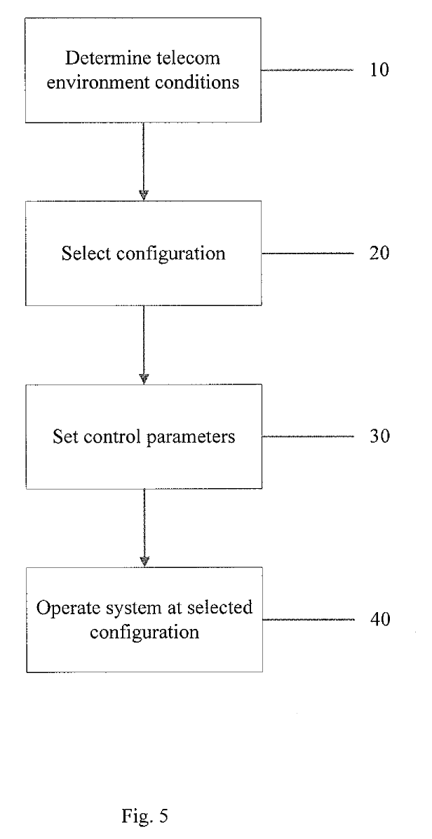

FIG. 5 is a flowchart showing a method of managing the operation of a telecommunication system according to an embodiment. In step 10, conditions of the telecommunication system environment are determined. The conditions may include, for example, traffic conditions, an average rate constraint, instantaneous queuing delay, load, and/or channel conditions. In step 20, a configuration is selected based at least in part on the environmental conditions. The configuration may, for example, be selected so that power is minimized while meeting minimum signal quality under the conditions determined in step 10. In step 30, control parameters are set so as to cause the system to operate in the selected configuration. The control parameters may include, for example, channel speed, transmission power, modulation rate, and code rate. In step 40, the system is operated in the configuration selected in step 20 after setting the control parameters in step 30.

What is claimed is:

1. A method of managing the operation of a system comprising a processing subsystem configured to run a multimedia application and a telecommunication subsystem, the method comprising:
determining telecom environment conditions;
selecting a configuration from a plurality of configurations, wherein the selecting is based at least in part on the determined environmental conditions, the configurations having been determined by simultaneously updating control parameters by a controller of both the multimedia application and the telecommunication subsystem;
setting control parameters in at least one of the multimedia application and the telecommunication subsystem to cause the system to operate at the selected configuration, wherein the control parameters comprise channel speed; and
operating the system at the selected configuration.

2. The method of claim 1, wherein at least some of the configurations differ in that they correspond to different control parameters to be set on both said multimedia application and said telecommunication subsystem.

3. The method of claim 1, wherein said telecommunication subsystem comprises a single telecom device.

4. The method of claim 1, wherein said telecommunication subsystem comprises a plurality of telecom devices.

5. The method of claim 4, wherein operating said telecommunication subsystem comprises setting control parameters corresponding to said selected configuration for each telecom device.

6. The method of claim 4, wherein said telecom environment conditions comprise at least one of path loss and channel frequency selectivity.

7. The method of claim 1, wherein the telecom environment conditions comprise one or more channel states.

8. The method of claim 7, wherein performance-energy trade-off curves are derived for each of the one or more channel states.

9. The method of claim 8, wherein energy-per-bit is used as an energy metric in the performance-energy trade-off curves.

10. The method of claim 1, wherein the plurality of predetermined configurations define a monotonic curve.

11. The method of claim 1, further comprising determining the plurality of configurations.

12. The method of claim 11, wherein determining the plurality of configurations is based on the determined telecom environment conditions.

13. The method of claim 1, wherein said telecommunication subsystem comprises a wireless telecommunication subsystem.

14. The method of claim 13, wherein said wireless telecommunication subsystem comprises a receiver comprising an equalizer.

15. The method of claim 1, wherein the plurality of configurations corresponds to a discrete set of telecom environment conditions.

16. The method of claim 15, wherein the discrete set of telecom environment conditions is organized by channel state.

17. A device operable according to the method of claim 1 wherein the selecting of a configuration comprises updating an equalization error, the device comprising a controller configured to update the configurations.

18. A device according to claim 17 wherein the controller is a closed loop controller.

19. A device according to claim 17 wherein the controller is a PID controller.

20. A device according to claim 17 wherein the device is integrated on a chip.
